(19) United States
(12) Patent Application Publication
(10) Pub. No.: US 2018/0155170 A1
(43) Pub. Date: Jun. 7, 2018

(54) HIGH-LIFT INDUSTRIAL TRUCK

(71) Applicant: Jungheinrich Aktiengesellschaft, Hamburg (DE)

(72) Inventors: Markus Nagel, Hamburg (DE); Alexander Hofmann, Hamburg (DE)

(73) Assignee: Jungheinrich Aktiengesellschaft, Hamburg (DE)

(21) Appl. No.: 15/829,392

(22) Filed: Dec. 1, 2017

(30) Foreign Application Priority Data
Dec. 2, 2016 (DE) 10 2016 123 326.9

(51) Int. Cl. B66F 9/16; B66F 9/08

(52) U.S. Cl. CPC B66F 9/16; B66F 9/08

(57) ABSTRACT

A high-lift industrial truck is provided comprising: a lift frame configured to mount a lift fork having a least one fork arm, the lift frame having at least two mast profiles that are spaced apart and are connected by at least one traverse, a cargo sledge disposed between the mast profiles and having at least two vertically spaced rollers disposed within the guide tracks of each mast profile, and a lifting device for raising and lowering the lift fork in the lift frame. Each mast profile has guide tracks defining spaced-apart running surfaces which extend perpendicularly of the lift fork and includes a lower section proximal to the ground and an upper section disposed vertically above the lower section. The running surfaces of the lower section defines a transverse distance across the surfaces which is greater than a transverse distance between the running surfaces defined by the upper section. As such, the tip end of the fork arm is lower relative to the root end when at least the lower roller of the at least two vertically space rollers is located in the lower section near the ground.

### CROSS REFERENCE TO RELATED INVENTION

This application is based upon and claims priority to, under relevant sections of 35 U.S.C. §119, German Patent Application No. 10 2016 123 326.9, filed Dec. 2, 2016, the entire contents of which are hereby incorporated by reference.

### BACKGROUND

As is well-known in the art, a distinction is generally made among industrial trucks, i.e., between low-lift and high-lift industrial trucks. With respect to the latter, a load can be lifted to a predetermined height for the purpose of stacking it in a shelf or the like. High-lift industrial trucks have a lift frame with a lift mast. The lift mast comprises at least two mast profiles, which are spaced apart, approximately in parallel to each other, and which are connected to each other by at least one cross member connection. The cargo sledge of a lift fork is guided within the lift mast, and the lift fork picks up a load by means of a pair of fork arms. For each mast profile, the cargo sledge has at least two rollers, which are vertically spaced apart and are guided within paths or channels of the mast profiles. For this reason, the cross-section of the mast profiles is preferably U-shaped, resulting in two spaced-apart running surfaces that extend substantially or nearly perpendicularly to the extent of the fork arms.

To pick up a load from the ground, the fork arms must move into an opening in a loading aid (palette). The fork arms are lowered as far as possible in order to enter the loading aid with as little ground clearance as possible. In so doing, tips of the fork arms should be equal to or lower than the height of the root of each arm . During lifting, the lift frame and lift fork deform elastically to an extent that naturally depends upon the size or weight of the load. This causes the fork arms to tend to slant downward. Hence, unloaded fork arms that extend approximately horizontally pose a risk that, when a load is picked up, the load could slip off of the fork as a result of the resulting gradient. Therefore, when a load is picked up, the fork arms should be extended at least horizontally or inclined slightly upward when the lift fork is loaded upon being raised or lowered. As indicated above, this state is critical when picking up the load from the ground. In so doing, the fork arms should run horizontally, at most, or inclined slightly downward. In order to satisfy these two contradictory requirements, the lift frame must be constructed geometrically in a narrow tolerance band. It will be appreciated that significant effort much be invested in the manufacture and assembly of the fork lift truck to maintain the narrow tolerance band required for its proper operation, can be achieved only with significant effort in assembly and production.

Some high-lift industrial trucks are known, e.g. counterbalanced and reach trucks, that permit a hydraulic adjustment of the mast inclination. In this way, the inclination of the fork arms can be freely set, or adjusted, within limits, depending on various requirements. However, hydraulic adjustment of the mast inclination is relatively laborious and normally not economically justifiable or fiscally advantageous for the high-lift truck.

The foregoing background describes some, but not necessarily all, of the problems, disadvantages and shortcomings related to archery release devices and methods of the prior art.

### BRIEF SUMMARY OF THE INVENTION

A high-lift industrial truck is provided comprising: a lift frame configured to mount a lift fork having a least one fork arm, the lift frame having at least two mast profiles that are spaced apart and are connected by at least one traverse, a cargo sledge disposed between the mast profiles and having at least two vertically spaced rollers disposed within the guide tracks of each mast profile, and a lifting device for raising and lowering the lift fork in the lift frame.

Each mast profile has guide tracks defining spaced-apart running surfaces which extend perpendicularly of the lift fork and includes a lower section proximal to the ground and an upper section disposed vertically above the lower section. The running surfaces of the lower section defines a transverse distance across the surfaces which is greater than a transverse distance between the running surfaces defined by the upper section. As such, the tip end of the fork arm is lower relative to the root end when at least the lower roller of the at least two vertically space rollers is located in the lower section near the ground.

A high-lift industrial truck is provided comprising: a lift frame configured to mount a lift fork having a least one fork arm, the lift frame having at least two mast profiles that are spaced apart and are connected by at least one traverse, a cargo sledge disposed between the mast profiles and having at least two vertically spaced rollers disposed within the guide tracks of each mast profile, and a lifting device for raising and lowering the lift fork in the lift frame.

Additional features and advantages of the present disclosure are described in, and will be apparent from, the following Brief Description of the Drawings and Detailed Description.

### BRIEF DESCRIPTION OF THE DRAWINGS

FIG. 1 shows a perspective schematic view of a high-lift industrial truck having a lift fork and an isolated perspective view of the lift fork.

FIGS. 2 and 3 show partially sectioned side views of the lift mast including the lift fork in: (i) a slightly raised position relative to a lowermost or ground position (FIG. 2) and (ii) the lowermost or ground position (see FIG. 3) wherein the rollers of the fork lift engage a guide surface of the lift mast so as to change inclination of the lift arms from a first inclination (in FIG. 2) to a second inclination (in FIG. 3)

FIG. 4 shows a schematic representation of the industrial truck according to FIG. 1 wherein a first view shows the lift arms in a fully lowered, horizontal position and a second view shows the lift arms in a slightly raised, upwardly-inclined position.

### DETAILED DESCRIPTION OF THE INVENTION

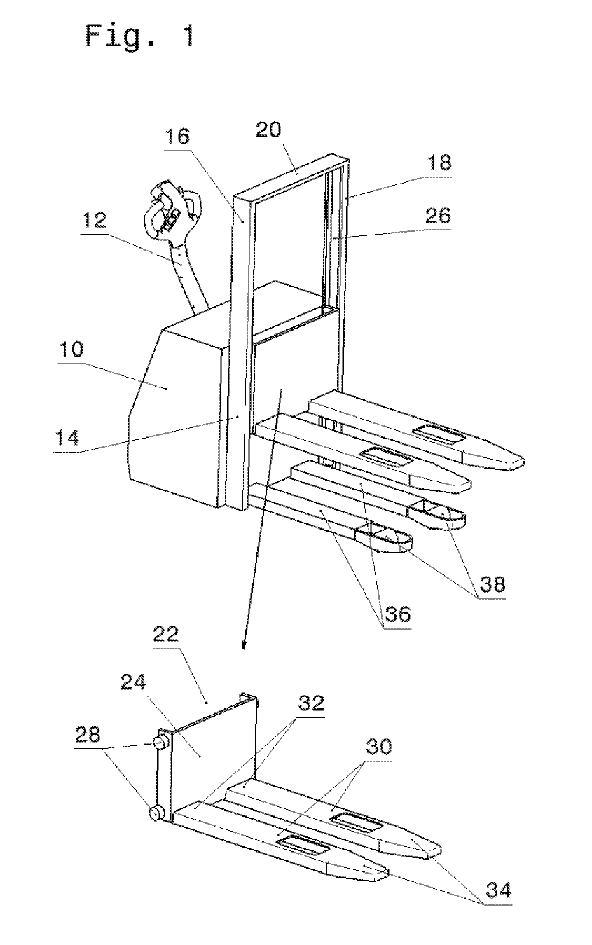

The industrial truck shown in FIG. 1 has a drive component 10, with a steering bar 12 so that the vehicle can be actuated by an operator. A lift frame 14 is arranged on the drive component 10, with two vertical profiles 16, 18 that are spaced apart and are connected to each other at the upper end by a cross member or traverse 20. The lift frame 14 is permanently attached to the drive component 10 or its frame, respectively. A lift fork 22 is guided within a lift frame 14 such that the lift fork 22 moves vertically upward by a lifting device (not shown). The lift fork 22 has a cargo sledge 24, which is guided within guide tracks of the vertical profiles 16, 18. Only one guide track 26 can be seen in FIG. 1. The cargo sledge 24 includes a pair of rollers 28 (only two rollers being viewable in FIG. 1): (i) having axes which are orthogonal relative to the lift forks 22, and (ii) engaging the guide tracks 26 of the lift frame 14. Preferably, at least two guide rollers 28 are mounted in an elevated position in each profile 16, 18 and the fork arms 30 are fastened to the cargo sledge 24. The fork arms 30 furthermore, have arm roots 32 in the connection region and arm tips 34 at the opposite free end.

In the illustrated embodiment, the industrial truck includes wheel arms 36, which are attached to the drive component 10 and spaced apart from each other in parallel. The wheel arms 36 support load rollers 38 disposed in a front portion of the arms 36 to stabilize the truck as it rolls along a horizontal surface, e.g., the floor of a warehouse.

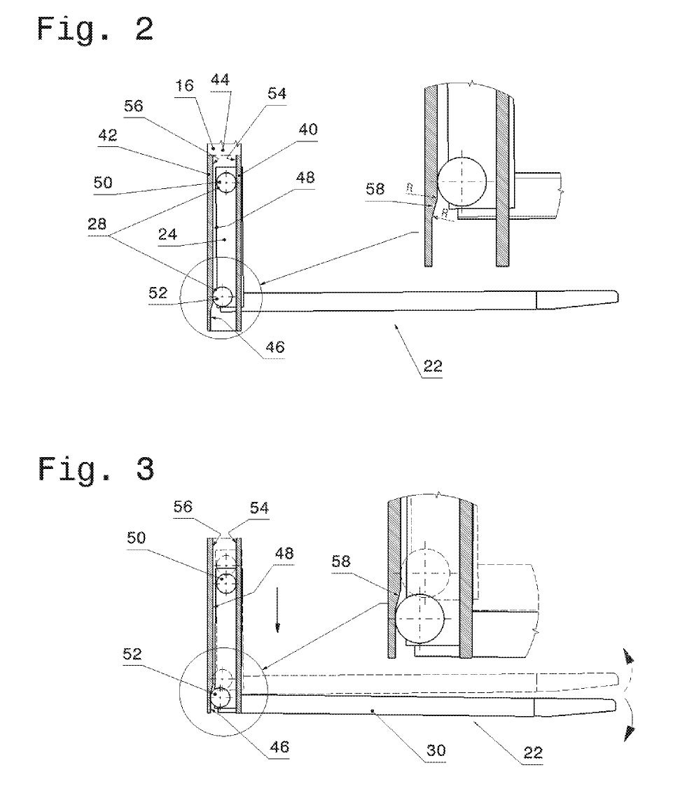

FIG. 2 shows a portion of a partially sectioned side view of the vehicle according to FIG. 1, wherein the profile 16 is sectioned such that the guide for the rollers 28 on the running surfaces 54, 56 of the profile 16 can be seen. The cross-sectional view shows the lift frame 14 and the lift fork 22 in an area proximal to the ground, wherein the drive component 10 and the wheel arms 36 are not shown. An enlarged sectional view of the lower roller 52 is shown as a detail to the right side of the vertical profiles 16, 18. The profile 16 is U-shaped or I-shaped and has two limbs 40, 42, which connected by a web or crosspiece 44. In FIG. 2, limb 40 includes a lower section 46 near the ground of the running surface 56 of the guide track and an upper section 48 of the running surface 56 of the guide track lying above it. Two rollers 50, 52 with radii R1, R2 run within the guide track and are mounted laterally on the cargo sledge 24. Running surfaces 54, 56 are formed on both of the limbs 40, 42. The limbs 40, 42 are parallel to and spaced apart from each other and, in the transverse direction, and are approximately or substantially perpendicular to the fork arms 22.

It can further be discerned in FIG. 2 that a ramp-like transition 58 is provided between the running surface 56 in the lower section 46 near the ground and the upper section 48 disposed vertically above the lower section 46. The transverse distance between the running surfaces 54, 56 is smaller in the upper section 48 (a) than in the lower section 46 (a+x). The ramp-like transition 58 is rounded at the ends, as indicated by the radius R, so that the rollers smoothly roll along the running surfaces 54, 56 without jerking of the lift fork 22 as the fork 22 is raised or lowered from one of the sections 46, 48 to the other of the sections 46, 48. The position of the rollers 50, 52 in the upper section 48 is illustrated in FIG. 2. In this view, the arms 30 of the fork 22 extend approximately in a horizontal plane parallel to the ground.

In contrast to FIG. 2, FIG. 3 shows in unbroken lines a position of the lift fork 22 in the area near the ground. This position is reached by lowering the lift fork 22. The lower roller 52 of the sledge 26 is located in the section 46 near the ground and thus remains in contact with the running surface 56. However, it is at an increased distance (a+x) from the running surface 54 compared to the upper section 48. As a result, the lift fork 22 tilts by a particular amount so that the fork arms 30 are inclined somewhat downward toward the tip. To represent the difference from the position of the lift fork 22 in the upper section 48, this upper position is indicated with a dashed line.

The tilting of the lift fork 22 is caused by the torque generated by the weight of the fork arms, shown here rotating clockwise. Accordingly, the upper roller 50 always rests against running surface 54, and the lower roller 52 always rests against running surface 56. If the distance between running surface 56 and running surface 54 changes, then the lift fork tilts in a clockwise direction by a particular amount. The amount naturally depends upon the different measurements of the distance between the running surfaces 54, 56 in the section 46 near the ground and the upper section 48. In the embodiment shown, the transition 58 is formed in running surface 56 lying on the side of the rollers facing away from the fork arms 30. It is also possible to provide this transition in running surface 54. In this instance, as the lift fork is lowered the lift fork is also tilted clockwise when the upper roller 50 has passed the transition 58, which in this embodiment is mirrored on running surface 54 and must be offset upward by the vertical distance between the rollers 50 and 52 so that the upper roller 50 reaches this mirrored transition 58.

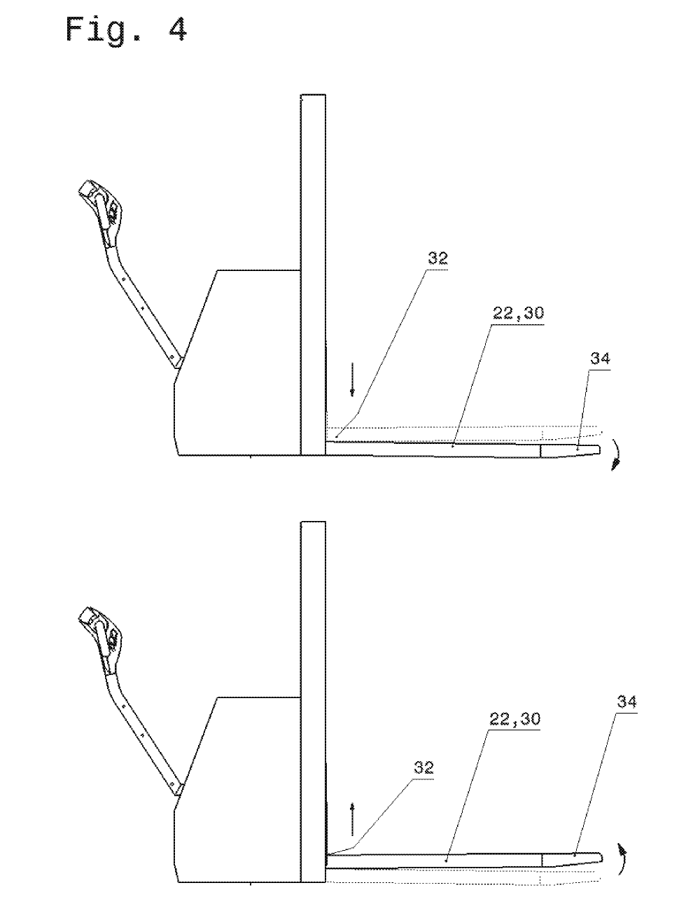

FIG. 4 again shows a schematic representation of how the invention functions. In the upper view in FIG. 4, the lift fork 22 is almost completely lowered. The fork arms 30 are then horizontal or slope downward from the root 32 (attachment to the cargo sledge) to the tip 34 (free end). In the lower view in FIG. 4, the lift fork 22 is lifted slightly. In this case, the fork arms 30 are horizontal or are inclined slightly upward from the fork root 32 (attachment to the cargo sledge) to the tip (free end) 34.

It is clear that the inclination of the fork arms is also determined by the position of the roller axles relative to each other. This is a matter of production, which, for given dimensions of the running surface spacing, allows the position of the lift fork to be finely adjusted. The inclination of the fork arms can later be influenced during assembly by the use of rollers with other diameters.

In summary, the distance between the running surfaces in a lower section of the guide tracks in close proximity to the ground is greater than the distance between the running surfaces in an upper section above it such that, when at least the lower roller is located in the section near the ground, the tips of the arms are lower relative to the arm roots than in a position with both rollers in the upper section.

The running surfaces of the guide tracks in the lift frame, or in the profile of the mast, respectively, are configured in such a way that the extension of the fork arms change during the lift. The invention proceeds from the knowledge that the projecting fork arms produce a force couple on the axles of the guide rollers. In this case, the upper roller abuts the running surface near the fork, while the lower roller lies against the opposite running surface. In the installed state, the inclination of the fork arms depends upon the radii R1 and R2 of the rollers as well as their geometric position relative to the fork arms and the distance a between the running surfaces. The dimension b, which is yielded by the aforementioned basic conditions (b=a−R1−R2), determines the inclination of the fork arms. If both rollers are located in the area with a distance between the running surfaces equalling a, then the inclination of the fork is approximately horizontal, for example. If one of the rollers then moves into the area with a distance a+x between the running surfaces, then it becomes clear that the amount x increases dimension b and that this brings about a downward change in the inclination of the fork arms.

Thus by appropriately configuring the spacing of the running surfaces, it is possible to ensure that, relative to the roots of the arms (attachment to the cargo sledge), the tips of the arms either lie in a horizontal plane or somewhat lower than the roots of the arms (attachment to the cargo sledge) in the section of the guide tracks near the ground. This facilitates the insertion of the fork arms into a palette, for example. When the cargo sledge is lifted, the rollers move into the upper section of the guide tracks. The arm tips thereby rise by a particular amount relative to the arm roots, and so the plane spanned by the tips and roots of the arms either is horizontal or inclines slightly upward toward the tip. This accommodates the transport and stacking of a load. As was mentioned, lifting a load onto the lift fork causes a deformation to the effect that the arms of the fork incline slightly downward compared to the unloaded state. If the plane of the load arms tilts slightly upward when they are not carrying a load, then the deformation of the lift frame and the lift fork once a load is picked up will result in nothing more than that the fork arms are positioned in a horizontal plane, but are not inclined downward with the risk that the load will slide off.

The inclination of the fork arms are positioned or influenced such that it is optimal for the operating or loading conditions in each case. In one embodiment of the invention, the distance between the running surfaces in the lower section near the ground is greater than in the upper section. One of the two rollers, which are located one above the other, moves into this area as it is lowered.

In another embodiment, a dimension is defined for the distance between the running surfaces relative to the diameter and the geometric position of the rollers without a load on the fork arms. More specifically, a plane defined by the tips and roots of the arms is approximately horizontal or tilts slightly downward toward the tip in the lower section near the ground, and that the plane is horizontal or tilts slightly upward toward the tip in the upper section.

To modify the spacing of running surfaces between the lower and upper sections, an offset within the running surface is necessary. In this embodiment, the running surfaces have a ramp-like transition between the lower and upper sections. The beginning and end of the ramp-like transition are preferably rounded. In this way, the rollers may traverse the transition without a jerking motion of the fork arms.

The configuration of the lift mast, the spacing between the running surfaces and the inclination of the lift arms is elegantly simple. The lift frame and mast require the machining of a running surface of the mast profiles in the lift frame. That is, by configuring the spacing of all running surfaces in the lower and in the upper section, the inclination of the fork arms can be specifically set. Furthermore, the setting may be selected in such a way that a load can easily be lifted in the area near the ground and so that the load can be transported and stacked securely with a raised lift fork.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

1. A high-lift industrial truck comprising:
a lift frame configured to mount a lift fork having a least one fork arm, the lift frame having at least two mast profiles that are spaced apart and that are connected by at least one traverse, each mast profile having guide tracks defining spaced-apart running surfaces which extend perpendicularly to the lift fork, the guide tracks having a lower section proximal to the ground and an upper section disposed vertically above the lower section;
a cargo sledge disposed between the at least two mast profiles and having at least two vertically spaced rollers disposed within the guide tracks of each mast profile;
the at least one fork arm having a tip end and a root end attached to the cargo sledge; and
a lifting device for raising and lowering the lift fork in the lift frame;
wherein the running surfaces of the lower section of guide tracks define a transverse distance across the running surfaces which is greater than a transverse distance between the running surfaces defined by the upper section such that the tip end of the at least one fork arm is lower relative to the root end of the at least one fork arm when at least a lower roller of the at least two vertically spaced rollers is located in the lower section near the ground.

2. The industrial truck according to claim 1, wherein the distance between the running surfaces in the upper section is greater than or equal to the diameter of the at least two vertically spaced rollers, and the distance between the running surfaces in the lower section near the ground permits the lift fork to tilt further than in the upper section.

3. The industrial truck according to claim 1, wherein a dimension is defined between the running surfaces relative to the diameter of the at least two vertically spaced rollers and the geometric position relative to the at least one fork arm without a load on the at least one fork arm, wherein a plane defined by the tip end and the root ends of the at least one fork arm is tilts slightly downward toward the tip when at least one of the rollers of the at least two vertically spaced rollers is in the lower section near the ground,

4. The industrial truck according to claim 3, wherein the plane tilts slightly upward when the vertically spaced rollers are both in the upper section.

5. The industrial truck according to claim 1, wherein at least one of the running surfaces has a ramp-like transition between the lower section near the ground and the upper section.

6. The industrial truck according to claim 5, wherein a beginning and an end of the ramp-like transition are rounded.

7. The industrial truck according to claim 6, wherein the ramp-like transition is positioned vertically such that the at least two vertically spaced rollers are already in the upper section once a load has been completely lifted and no longer is in contact with the ground.
